(19) United States
(12) Patent Application Publication
(10) Pub. No.: US 2010/0162342 A1
(43) Pub. Date: Jun. 24, 2010

(54) PARENTAL CONTROLS FOR MULTIPLE DEVICES

(75) Inventors: David J. Piepenbrink, Chicago, IL (US); Lee M. Chow, Naperville, IL (US); James T. Sofos, Aurora, IL (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/341,338

(22) Filed: Dec. 22, 2008

(51) Int. Cl. G06F 21/20; H04N 7/173; H04W 84/02; G06F 17/30; H04L 9/32

(52) U.S. Cl. 725/132; 370/328; 726/1; 726/28; 726/18; 707/E17.044

(57) ABSTRACT

A method of controlling access to electronic content across a plurality of devices includes creating a user profile associated with a user based on profile input from the user or an administrator and generating a universal content control profile (UCCP) based on the user profile. At least one of the user profile and the UCCP is then stored to a computer readable storage medium. Based on the UCCP and a device-type of a selected electronic device, a content control setting (CCS) is determined for the selected electronic device. Upon detecting a communication channel with the selected electronic device, the method includes providing the CCS to the selected electronic device.

### BACKGROUND

1. Field of the Disclosure

The present disclosure relates to content management and, more particularly, parental based controls on access to content by children.

2. Description of the Related Art

The use of parental controls and other types of content controls is well known for preventing or limiting access to electronic content, especially including preventing or limiting access by children. Generally, conventional parent control techniques have been device-centric with each type of device or service providing support for highly localized and user specific parental control functionality.

### BRIEF DESCRIPTION OF THE DRAWINGS

FIG. 1 is a block diagram of selected elements of an embodiment of home environment emphasizing multiple electronic devices;

FIG. 2 is a block diagram illustrating selected elements of an embodiment of a multimedia handling device suitable for use in the environment of FIG. 1;

FIG. 3 is a flow diagram illustrating selected elements of a method for providing universal content control restrictions;

FIG. 4 depicts aspects of an exemplary user profile;

FIG. 5 illustrates a client application accessing a user profile to generate a universal content control profile; and

FIG. 6 illustrates the integration of a universal content control profile and a set of industry specific or device specific or media-type specific ratings or guidelines to develop content control settings that are specific to and compatible with a particular electronic device.

### DESCRIPTION OF EXEMPLARY EMBODIMENTS

In one aspect, a disclosed method of controlling access to electronic content across a plurality of devices includes creating a user profile, associated with a user, based on profile input provided by the user or an administrator. A universal content control profile (UCCP) is then generated based on the user profile. At least one of the user profiles and the UCCP is stored to a computer readable storage medium. The disclosed method further includes determining, based on the UCCP and a device-type of a selected electronic device, a content control setting (CCS) for the selected electronic device. When a communication channel with the selected electronic device is subsequently detected, the CCS is provided to the selected electronic device.

The method may be provided as a special purpose application executing on a set top box or other type of customer premises equipment of the user or a subscriber associated with the user including for example, a subscriber/administrator who is a parent and a user who is the parent's child. A user profile interface that facilitates entry of the profile input may be provided to the user or administrator via a set top box or via a web browser.

The method may include generating a password associated with the CCS and implementing the password on the selected electronic device. Providing the CCS to the electronic device may occur after detecting a communication connection including, as examples, an 802.11-type (WiFi) connection, a Bluetooth connection, a wired Ethernet connection, and a cellular telephony connection.

Determining the CCS may include applying the UCCP to or integrating the UCCP with content-type specific standards. The content-type specific standards may be selected from the group consisting of Motion Picture Association of America (MPAA) standards, TV Parental Guidelines, Entertainment Software Ratings Board (ESRB) standards, and the like. The UCCP may be generated based entirely, substantially, or partially on the age of the user as indicated in the user profile. Alternatively, the UCCP may be generated based on an adjusted user age. The adjusted user age may represent the actual age of the user plus or minus an age adjustment that reflects, for example, the user's maturity level relative to the user's peers. A user with advanced maturity might warrant an adjusted user age that exceeds the user's actual age while an immature user might benefit from an adjusted user age that is less than the user's actual age.

In other aspects, the disclosed subject matter is implemented as a computer or other type of data processing system. The computer includes a computer readable storage medium having instructions for implementing universal content control. In other embodiments, the disclosed subject matter encompasses an optical disc or other type of computer readable medium on which are stored instructions for carrying out a method of centralizing content control or parental control in a single application capable of communication with all or most of the electronic devices to which the user has access.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

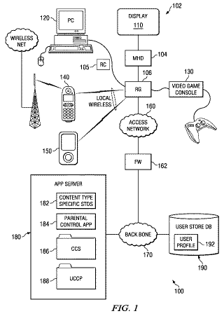

Referring to FIG. 1, a block diagram depicting selected elements of an embodiment of an environment 100 suitable for implementing universal content control as described herein is presented. In the depicted embodiment, environment 100 includes various electronic devices, each of which may have functionality enabling parents, guardians, or other administrators to invoke parental control or another type of content control mechanism. Environment 100 as depicted in FIG. 1 includes elements of client-side hardware used in conjunction with multimedia content delivery services including, as examples, Internet protocol television (IPTV) as well as conventional cable television systems. Although the depicted embodiment of environment 100 illustrates or emphasizes specific features and/or services, other embodiments may include or emphasize fewer, more, and/or different features and/or services.

As depicted in FIG. 1, environment 100 includes various consumer electronic devices including a video game console 130, a desktop or laptop personal computer (PC) 120, a cellular telephony device 140, a media player 150, and a display 110 connected to a multimedia handling device (MHD) 104. MHD 104 may be implemented as a set top box and display 110 may be part of a television. A remote control 105 operates in conjunction with MHD 104.

A residential gateway (RG) 106 provides an interface and enables a connection between the client side electronic devices and an access network 160. Access network 160 may be a private network operated by an Internet service provider, an IPTV or other type of multimedia content provider, or another operator.

RG 106 may be operable to establish communication channels with each of the various types of electronic devices operated within environment 100. RG 106 may support, for example, wired Ethernet connections and various local wireless protocols including IEEE 802.11-family (WiFi) connections, Bluetooth connections, and so forth. In the depicted embodiment, wireless telephony device 140 and media player 150 are illustrated communicating with RG 106 via a local wireless protocol. In addition, PC 120 and game console 130 are illustrated connected to RG 106 via a wired connection such as a wired Ethernet connection.

Access network 160 may be an IP-based network that enables connections between clients, such as the client 102 depicted in FIG. 1, and a backbone network 170 of the service provider. Backbone network 170 may be insulated from access network 160 by a firewall 162 designed to reduce the prospect of an attack on access network 160. Backbone network 170 may represent a fiber optic or other type of broadband network designed to carry a service provider's mission critical applications and data between network endpoints.

As depicted in FIG. 1, an application server 180 and a user store database 190 are depicted connected to backbone network 170. In the depicted embodiment, application server 180 includes various software modules including as depicted, a parent control application 184, as well as a set of data structures including, as examples, content-type specific standards 182, CCS 186 and a UCCP 188. In addition, user store database 190 includes a user profile 192.

Referring now to FIG. 2, a block diagram illustrating selected elements of an embodiment of MHD 104 is presented.

In the embodiment depicted in FIG. 2, MHD 104 includes processor 201 coupled via shared bus 202 to storage media collectively identified as storage 210. MHD 104, as depicted in FIG. 2, further includes network adapter 220 that interfaces MHD 104 to RG 106 and through which MHD 104 receives multimedia content.

In embodiments suitable for use in IP based content delivery networks, MHD 104, as depicted in FIG. 2, may include transport unit 230 that assembles the payloads from a sequence or set of network packets into a stream of multimedia content. In coaxial based access networks, content may be delivered as a stream that is not packet based and it may not be necessary in these embodiments to include transport unit 230. In a co-axial implementation, however, clients 102 may require tuning resources (not explicitly depicted in FIG. 2) to “filter” desired content from other content that is delivered over the coaxial medium simultaneously and these tuners may be provided in MHD 104. The stream of multimedia content received by transport unit 230 may include audio information and video information and transport unit 230 may parse or segregate the two to generate video stream 232 and audio stream 234 as shown.

Video and audio streams 232 and 234, as output from transport unit 230, may include audio or video information that is compressed, encrypted, or both. A decoder unit 240 is shown as receiving video and audio streams 232 and 234 and generating native format video and audio streams 242 and 244. Decoder 240 may employ any of various widely distributed video decoding algorithms including any of the Motion Pictures Expert Group (MPEG) standards or Windows Media Video (WMV) standards including WMV 9 which has been standardized as Video Codec-1 (VC-1) by the Society of Motion Picture and Television Engineers. Similarly decoder 240 may employ any of various audio decoding algorithms including Dolby® Digital, Digital Theatre System (DTS) Coherent Acoustics, and Windows Media Audio (WMA).

The native format video and audio streams 242 and 244 as shown in FIG. 2 may be processed by encoders/digital-to-analog converters (encoders/DACs) 250 and 260 respectively to produce analog video and audio signals 252 and 254 in a format compliant with display 110, which itself may not be a part of MHD 104. Display 110 may comply with National Television System Committee (NTSC), Phase Alternating Line (PAL) or any other suitable television standard.

Storage 210 encompasses persistent and volatile media, fixed and removable media, and magnetic and semiconductor media. Storage 210 is operable to store instructions, data, or both. Storage 210 as shown includes sets or sequences of instructions, namely, an operating system 212, a remote control application program identified as RC module 214, and a universal content control (UCC) client application 216. Operating system 212 may be a UNIX or UNIX-like operating system, a Windows® family operating system, or another suitable operating system. In some embodiments, storage 210 is configured to store and execute instructions provided as services to client 102 by an application server.

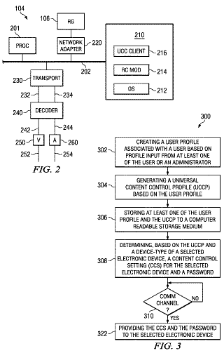

In some embodiments, universal content control as disclosed herein is implemented in software or primarily in software or software components. In these embodiments, universal content control may be implemented as a set of computer executable instructions stored on a computer readable medium. The instructions may be operable, when executed, to execute a process such as the process 300 depicted in FIG. 3.

Referring to FIG. 3, the depicted flow diagram represents an embodiment of a process for implementing universal content control. In the depicted embodiment, method 300 includes creating (block 302) a user profile associated with a user. The user profile may be based on profile input provided by the user or an administrator. In some applications, the user represents the individual, e.g., a child, whose content access privileges are being controlled by an administrator of environment 100. The administrator represents the parent, guardian, or other caretaker of the user. The user profile may include characteristics of the user including, for example, name, address, age, content preferences, areas of interest, occupation, school, and so forth. In addition, the user profile may include information specific to the user including, as examples, email address, screen names, identities, and so forth.

Method 300 as shown further includes generating (block 304) a UCCP based on the user profile and storing (block 306) the user profile, the UCCP, or both to a computer readable storage medium including, for example, storage 210 depicted in FIG. 2. Based on the UCCP and a device-type of a selected electronic device, a CCS is determined (block 308) for the user and the selected electronic device.

After the CCS is determined in block 308, the CCS is provided (block 322) to the selected electronic device when a communication channel can be established (block 310) between the device executing the UCCS client application. For example, if MHD 104 is executing UCCS client application 216, the CCS is provided to the electronic device when a communication channel between the electronic device and the MHD 104 and, more precisely, when a communication channel between the electronic device and MHD 104 is established via RG 106. For electronic devices including cellular telephony device 140 and media player 150 that connect to RG 106 wirelessly, the CCS is provided to the electronic device when the device is brought within local wireless range of RG 106. For electronic devices 120 and 130 that connect to RG 106 via a wireline connection depicted in FIG. 1, the CCS is provided to the electronic device when the electronic device (120 or 130) is connected to an Ethernet or other suitable port of RG 106.

FIG. 4 depicts selected elements of an embodiment of a user profile 400 suitable for use in the universal content control methods described herein. In the depicted embodiment, user profile 400 includes a set of entries 410 including entries 410-1 and 410-2, which are explicitly depicted. In the depicted embodiment, each entry 410 includes a user field 402, an age field 404, and a profile setting 406. The user field 402 may include a full name, a given name or other type of nickname, a screen name, and so forth. The age field 404 indicates the user's age and the profile setting field 406 may be used to enable an administrator to adjust the content control settings that are produced, based on the administrator's perception about the maturity of the applicable user relative to the user's peers.

As depicted in FIG. 4, profile setting field 406 may include any of at least four values including a +n value, an A value, a −n value, and a C value. In the depicted embodiment, the A value may be the default and indicates the administrator's desire for the UCCS client application 216 to generate content control settings for the user based solely or primarily on the user's age. This setting may be appropriate when the user is of average maturity relative to the user's peer group.

If an administrator perceives that the applicable user is more or less mature or emotionally or mentally developed than the user's peers, the administrator may implement this perception in the content control settings by indicating a +n or −n value in the field 406 where n is an integer greater than or equal to 1. In some embodiments, a −n value in profile setting field 406 indicates the administrator's belief that the user is approximately n years developmentally younger than the user's peers. Conversely, a +n designation indicates a belief or desire to generate user settings that are typical of children n years older than the viewer.

Although the embodiment of user profile 400 includes just a single field 406 for defining default or automated content control settings, other embodiments may employ multiple fields 406 in user profile 400 to differentiate the profile settings field according to the content category. Thus, for example, profile 400 may include additional fields (not depicted) that indicate values for generating CCS settings for violent content, sexually suggestive or explicit content, content containing profane or offensive dialogue, and so forth.

FIG. 4 as shown also indicates “C” as a possible value for field 406. The C value may indicate a custom field in which content control settings are determined in a manual process. A value of C in the profile setting may cause UCCS client application 216 to stop automated generation of a UCCP and permit the administrator or user to define a profile for the user.

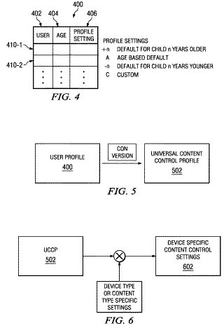

In some embodiments, UCCS client application 216 opens or otherwise accesses user profile 400, as depicted in FIG. 5, to generate a UCCP 502. UCCP 502 may indicate content control settings based on an open, universal, device-independent, device-type-independent standard for categorizing all types of content including computer-accessed content, e.g., web sites, blogs, chat rooms, social network sites, and so forth, multimedia content including video-on-demand and television content, music content, and so forth. The UCCP 502 may, for example, classify children according to one of several age-based categories where the upper and lower limits on each of the boundaries and the actual numbers of boundaries may predetermined by an open standards setting body.

FIG. 6 depicts selected elements of UCCS client application 216 generating device specific content control settings 602 based, at least in part, on the UCCP 502. As depicted in FIG. 6, UCCS client application 216 may retrieve or otherwise access UCCP 502 and obtain information indicative of any device type and/or content type settings specific to the user. Various industries may propose content ratings guidelines including age based guidelines, content based guidelines, or both. Examples of industry based ratings guidelines include the MPAA's well known ratings for motion pictures, the TV Parental Guidelines for broadcast and cable channel content in the United States, and the ESRB ratings for video games.

In some embodiments, UCCS client application 216 may generate or otherwise determine a CCS for a specific electronic device by integrating any device specific or industry standard ratings with the UCCP 502 to determine CCSs 602 that are specific to the electronic device and the content type that the electronic device plays.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method of controlling access to electronic content across a plurality of devices, the method comprising:
creating a user profile associated with a user based on profile input from at least one of the user or an administrator;
generating a universal content control profile (UCCP) based on the user profile;
storing at least one of the user profile and the UCCP to a computer readable storage medium;
determining, based on the UCCP and a device-type of a selected electronic device, a content control setting (CCS) for the selected electronic device; and
responsive to detecting a communication channel with the selected electronic device, providing the CCS to the selected electronic device.

2. The method of claim 1, further comprising:
generating, by a set top box, a user profile interface enabling the profile input; and
displaying the user profile interface on a display device connected to the set top box.

3. The method of claim 1, further comprising:
generating, by a web-based application, a user profile interface enabling the administrator to provide the administrator input; and
displaying the user profile interface via a web browser.

4. The method of claim 1, further comprising:
generating a password associated with the CCS; and
implementing the password on the selected electronic device.

5. The method of claim 1, wherein said providing the CCS is responsive to detecting a communication connection selected from the group consisting of: an 802.11-type (WiFi) connection, a Bluetooth connection, a wired Ethernet connection, and a cellular telephony connection.

6. The method of claim 1, wherein said determining of the CCS includes applying the UCCP to content-type specific standards.

7. The method of claim 6, wherein the content-type specific standards are selected from the group consisting of Motion Picture Association of America (MPAA) standards, TV Parental Guidelines, and Entertainment Software Ratings Board (ESRB) standards.

8. The method of claim 1, wherein said generating of the UCCP comprises generating the UCCP based on an age of the user as indicated in the user profile.

9. The method of claim 1, wherein said generating of the UCCP comprises generating the UCCP based on an adjusted user age, wherein the adjusted user age is computed based on an actual age of the user as indicated in the profile adjusted by an administrator provided age delta.

10. A computer program product comprising computer executable instructions, stored on a computer readable medium, for controlling access to electronic content across a plurality of devices, the instructions comprising instructions for:
creating a user profile associated with a user based on profile input from at least one of the user or an administrator;
generating a universal content control profile (UCCP) based on the user profile;
storing at least one of the user profile and the UCCP to a computer readable storage medium;
determining, based on the UCCP and a device-type of a selected electronic device, a content control setting (CCS) for the selected electronic device; and
responsive to detecting a communication channel with the selected electronic device, providing the CCS to the selected electronic device.

11. The computer program product of claim 10, further comprising instructions for:
generating a password associated with the CCS; and
providing the password to the selected electronic device.

12. The computer program product of claim 10, wherein said instructions for providing the CCS is responsive to a detecting a communication connection selected from the group consisting of: an 802.11-type (WiFi) connection, a Bluetooth connection, a wired Ethernet connection, and a cellular telephony connection.

13. The computer program product of claim 10, wherein said instructions for determining of the CCS includes instructions for applying the UCCP to content-type specific standards.

14. The computer program product of claim 13, wherein the content-type specific standards are selected from the group consisting of Motion Picture Association of America (MPAA) standards, TV Parental Guidelines, and Entertainment Software Ratings Board (ESRB) standards.

15. The computer program product of claim 10, wherein said instructions for generating of the UCCP comprises instructions for generating the UCCP based on an age of the user as indicated in the user profile.

16. The computer program product of claim 10, wherein said instructions for generating of the UCCP comprises instructions for generating the UCCP based on an adjusted user age, wherein the adjusted user age is computed based on an actual age of the user as indicated in the profile adjusted by an administrator provided age delta.

17. A processing system including processor and computer readable storage, accessible to the processor, the computer readable medium storing computer executable instructions for controlling access to electronic content, the instructions comprising instructions for:
creating a user profile associated with a user based on profile input from at least one of the user or an administrator;
generating a universal content control profile (UCCP) based on the user profile;
storing at least one of the user profile and the UCCP to a computer readable storage medium;
determining, based on the UCCP and a device-type of a selected electronic device, a content control setting (CCS) for the selected electronic device; and
responsive to detecting a communication channel with the selected electronic device, providing the CCS to the selected electronic device.

18. The system of claim 17, further comprising instructions for:
generating, by a set top box, a user profile interface enabling the profile input; and
displaying the user profile interface on a display device connected to the set top box.

19. The system of claim 17, wherein said instructions for providing the CCS is responsive to a detecting a communication connection selected from the group consisting of: an 802.11-type (WiFi) connection, a Bluetooth connection, a wired Ethernet connection, and a cellular telephony connection.

20. The system of claim 17, wherein said instructions for determining of the CCS includes instructions for applying the UCCP to content-type specific standards.

21. The system of claim 20, wherein the content-type specific standards are selected from the group consisting of Motion Picture Association of America (MPAA) standards, TV Parental Guidelines, and Entertainment Software Ratings Board (ESRB) standards.

22. The system of claim 17, wherein said instructions for generating of the UCCP comprises instructions for generating the UCCP based on an age of the user as indicated in the user profile.

23. The system of claim 17, wherein said instructions for generating of the UCCP comprises instructions for generating the UCCP based on an adjusted user age, wherein the adjusted user age is computed based on an actual age of the user as indicated in the profile adjusted by an administrator provided age delta.
